(19) United States
(12) Patent Application Publication
(10) Pub. No.: US 2026/0351670 A1
(43) Pub. Date: Nov. 5, 2026

(54) CROSSLINKED SOLID ELECTROLYTE FOR LITHIUM ION BATTERY

(71) Applicant: IFP Energies nouvelles, RUEIL-MALMAISON (FR)

(72) Inventors: Mona Marie OBADIA, RUEIL-MALMAISON CEDEX (FR); Niki HALTTUNEN, RUEIL-MALMAISON CEDEX (FR); Emmanuelle BRACCO, RUEIL-MALMAISON CEDEX (FR); David PASQUIER, RUEIL-MALMAISON CEDEX (FR)

(21) Appl. No.: 19/108,825

(22) PCT Filed: Sep. 6, 2023
(86) PCT No.: PCT/EP2023/074358

§ 371 Date: Mar. 5, 2025

(30) Foreign Application Priority Data
Sep. 12, 2022 (FR) FR2209113

(51) Int. Cl. H01M 10/0565; H01M 10/0525

(52) U.S. Cl. CPC H01M 10/0565; H01M 10/0525; H01M 2300/0082

(57) ABSTRACT

The present invention relates to a crosslinkable electrolyte formulation comprising at least:
a hydrocarbon molecule containing three to six thiol functions, preferably four;
a bifunctional chain extender in the form of a hydrocarbon chain bearing two C═C double bonds;
a monofunctional single-ion chain terminator containing a C═C double bond and comprising mobile lithium;
1 a monofunctional polyethylene glycol chain terminator;
a nucleophilic base catalyst,

wherein the [C═C double bond]/[thiols] molar ratio is 1.

The invention also relates to the preparation and use of a crosslinked solid electrolyte.

### TECHNICAL FIELD

The invention relates to the preparation of crosslinked solid electrolytes for lithium-ion batteries based on thiol-ene reactions.

### PRIOR ART

The thiol-ene reaction has applications in many fields, including batteries.

The thiol-ene (also alkene hydrothiolation) reaction is a reaction between a thiol and an alkene to form a thioether. This reaction was reported for the first time in 1905 but it assumed importance in the late 1990s and early 2000s for its feasibility and its wide range of applications, in particular for electrolytes.

Thiols are excellent nucleophiles through the formation of thiolate anions (RS) and are also electrophiles via thiyl radicals (RS*). One of the most studied reactions involving thiols is the hydrothiolation of (C═C) double bonds. Depending on the nature of the substituents of the double bond, i.e. electron donors or acceptors, and the type of catalyst employed, the thiol-C═C reaction can take place according to a radical or nucleophilic mechanism.

In the case of a nucleophilic mechanism, the reaction used is a Michael polyaddition, also referred to as a nucleophilic thiol-ene polyaddition, to a double bond substituted by an electron-withdrawing group, such as (meth)acrylates (monomers containing an active double bond), and a nucleophilic base is used as catalyst.

The Michael polyaddition reaction has applications in many fields.

Li et al. ACS Energy Letters 2018, vol. 3, p. 20-27. DOI: 10.1021/acsenergylett.7b00999 propose a single-ion polymer solid electrolyte synthesized from a photo-induced click chemistry reaction of an azide with an alkyne. It has a PEO (poly(ethylene oxide)) repeating unit and a TFSI (bis {(trifluoromethyl) sulfonyl}imide) counteranion attached to the polymer chain. No crosslinking agent is used, viscous liquid polymers are obtained and not networks (the mechanical and physicochemical properties are therefore totally different). Although the transport number is close to 1, the conductivity values described at 90 °C are of the order of 2×10⁻⁵ S.cm⁻¹.

Shen et al. ChemElectroChem 2019, vol. 6, 4483-4490. DOI: 10.1002/celc.201901045 propose a quasi-solid electrolyte in the form of a semi-interpenetrating network formed by a polyacrylate-based single-ion crosslinked polymer and a PEO matrix, thus unrelated to the thiol-ene reaction. The counteranion here is a sulfonate. A conductivity of 1.34×10⁻⁵ S.cm⁻¹ at 60 °C is observed owing to the addition of 5 μl of plasticizer (EC:PC 1:1 by vol) at the cathode-electrolyte interface at the time of assembling the button cell. The transport number is 0.77.

Du et al. ACS Appl. Energy Mater. 2020, vol. 3, 1128-1138. DOI: 10.1021/acsaem.9b02180 propose a quasi-solid single-ion electrolyte resulting from the solvent phase coating of a mixture of PVDF and a single-ion polyimide. The counteranion is a TFSI, but the electrolyte obtained is a physical network and not a chemical one, and furthermore the synthesis does not involve a thiol-ene reaction. It has a very good conductivity of 1.6×10⁻⁴ S.cm⁻¹ at 25 °C owing to its prior immersion in carbonate solvents during its electrochemical characterization. However, the presence of solvent is an impediment to the industrial development of this type of material, since the objective is to use a solid electrolyte precisely to avoid the thermal problems related to solvents in batteries (evaporation, pressure rise, risk of combustion). The transport number is 0.93.

Zhang et al. Energy Storage Material 2020, vol. 24, p. 579-587. DOI: 10.1016/j.ensm.2019.06.029 propose a quasi-solid single-ion electrolyte resulting from a photo-induced thiol-ene reaction from a mixture of four monomers dissolved in acetonitrile, deposited on a polypropylene nonwoven fabric. The counteranion is TFSI and the thiol crosslinking agent is pentaerythritol tetrakis(3-mercaptopropionate). The authors use a solvent in the starting mixture, and a support. Furthermore, it is noted that the membrane obtained is immersed in a mixture of ethylene carbonate and dimethylene carbonate before being characterized. The excellent conductivity of 8.4×10⁻⁴ S.cm⁻¹ at 25 °C is therefore not intrinsic to the material. Furthermore, the network presented does not contain PEO segments that facilitate ionic conduction in the absence of a significant amount of solvent.

Patent applications US 2016/0315348 A1, J. R. Long, J. Van Humbeck, R. P. Ameloot, Polymer network single-ion conductors and US 2018/0166744 A1, R. Long, J. Van Humbeck, J. C. Axelson, Polymer network single-ion conductors with flexible linkers describe single-ion polymer networks based on the borate anion (C₆F₄)₄B⁻. It is the tetrafluorophenyl borate anions which form the nodes and the neutral crosslinking agent which gives more or less mechanical flexibility depending on its chemical structure. The crosslinking agent, which therefore also acts as a spacer, presented as being the most advantageous is cis-2-butene-1,4-diol, because it makes it possible to obtain good structural flexibility. The network formation reaction is carried out in two steps: the deprotonation of cis-2-butene-1,4-diol by n-butyllithium, then the nucleophilic substitution between methyl chloride (derived from the lithium chloromethyl tetrafluorophenyl borate precursor) and the deprotonated cis-2-butene-1,4-diol. The final membrane is obtained by coating using the solvents N,N-dimethylformamide and 2,2′-azobis(2-methylpropionitrile). It is noted that the Young's modulus (E=0.27 GPa) and the ionic conductivity (σ=8.5×10⁻⁵ S.cm⁻¹ at 40 °C) are given for a membrane containing 30% by weight of plasticizer. Thus, the examples from these patents relate only to gels containing a very large amount of propylene carbonate.

### SUMMARY OF THE INVENTION

Surprisingly, the applicant company has noticed that, in nonaqueous formulations of solid electrolytes, crosslinking improved the mechanical properties of the network compared with the use of homopolymers, and that the use of a hydrocarbon molecule bearing between 3 and 6 thiol functions in association with a hydrocarbon molecule containing two C═C double bonds in the presence of a nucleophilic base catalyst, in which the [alkenes]/[thiols] molar ratio in the formulation is substantially stoichiometric, made it possible to increase the resistance of the network to chemical degradation. The [alkenes]/[thiols] molar ratio is understood to mean the molar ratio of all the C═C double bonds to all the thiol bonds of the formulation.

The electrolyte formulation according to the invention makes it possible in particular to obtain conductivities of several orders of magnitude greater than those obtained in the prior art (10⁻⁵ to 10⁻⁷ S/cm). The crosslinkable electrolyte formulation according to the invention makes it possible to obtain a self-supported chemical network with a transport number of 1 which can be synthesized in a single step by a thiol-ene reaction and without the use of solvent being necessarily required.

The invention relates to a crosslinkable electrolyte formulation comprising at least:
a hydrocarbon molecule containing three to six thiol functions, preferably four;
a bifunctional chain extender in the form of a hydrocarbon chain bearing two C═C double bonds;
a monofunctional single-ion chain terminator containing a C═C double bond and comprising mobile lithium;
a monofunctional polyethylene glycol chain terminator;
a nucleophilic base catalyst,

wherein the [C═C double bond]/[thiols] molar ratio is 1.

The formulation may comprise a soluble lithium salt or a mixture of soluble lithium salts in the formulation; the amount of lithium salt(s) may represent between 2% and 30% by weight, relative to the total formulation weight, preferably between 5% and 15% by weight, relative to the total formulation weight.

The catalyst may be chosen from 1,8-diazabicyclo [5.4.0]undec-7-ene, dimethylphenylphosphine, triphenylphosphine or triethylamine, pyridine and dimethylaminopyridine and preferably chosen from 1,8-diazabicyclo [5.4.0]undec-7-ene, dimethylphenylphosphine, triphenylphosphine or triethylamine, very preferably the catalyst is triethylamine.

The hydrocarbon molecule containing 3 to 6 thiol functions may be chosen from pentaerythritol tetrakis(3-mercaptopropionate), trimethylolpropane tris(3-mercaptopropionate), a poly [(mercaptopropyl)methylsiloxane] or a (mercaptopropyl)methylsiloxane-co-dimethylsiloxane copolymer with an average functionality of greater than or equal to 3, preferably is pentaerythritol tetrakis(3-mercaptopropionate).

The bifunctional chain extender may be chosen from any oligoethylene glycol unit bearing two C═C double bonds or any norbornene, vinyl ether, allyl ether, acrylate, methacrylate or alkene unit.

The bifunctional chain extender may be chosen from poly(ethylene glycol) dimethacrylate, PEG diacrylate, PEG diallyl, PEG divinyl.

The monofunctional single-ion chain terminator is preferably lithium 3-[(trifluoromethane) sulfonamidosulfonyl]propyl methacrylate.

The polyethylene glycol chain terminator may be chosen from poly(ethylene glycol) methyl ether acrylate, poly(ethylene glycol) allyl methyl ether, poly(ethylene glycol) vinyl methyl ether or poly(ethylene glycol) maleimide methyl ether.

The catalyst may be present in an amount such that the molar ratio of thiol functions to catalyst is between 200 and 600.

The formulation may comprise a second chain extender of the dithiol family, preferably chosen from polydimethylsiloxane (PDMS) or polyethylene glycol (PEG) polymers terminated with mercaptoethyl or mercaptopropyl functions at both ends.

The formulation may comprise a plasticizer chosen from the following compounds: oligoethylene glycol, carbonate ester, succinonitrile, polar aprotic solvent or aprotic ionic liquid, said plasticizer representing from 2% to 30%, preferably from 5% to 15% by weight, relative to the total formulation weight.

The invention also relates to a process for the preparation of a crosslinked solid electrolyte, in which:
a) the crosslinkable electrolyte formulation according to any one of the preceding variants is crosslinked, in the optional presence of a nonaqueous solvent, by means of the catalyst present in the formulation and by thermal activation, in order to form a polymer which conducts lithium ions,
b) the optional solvent present in said polymer is evaporated in order to obtain a crosslinked solid electrolyte.

The thermal activation may be carried out by heating the formulation at a temperature of between 50 °C and 80 °C for a period of between 1 and 24 hours and preferentially between 6 hours and 12 hours.

The invention also relates to the preparation of a crosslinked solid electrolyte in electrode form, wherein in step a) a porous electrode is impregnated with the crosslinkable electrolyte formulation by coating or spraying, and then the coated or sprayed formulation is crosslinked, or an active material and an electronic percolant are added to the crosslinkable electrolyte formulation in step a) to formulate an electrode ink which is coated and then crosslinked to obtain a solid electrode.

The invention lastly relates to the use of the crosslinked electrolyte obtained by crosslinking the formulation according to any one of the variants thereof or obtained by the process according to any one of the variants thereof as solid electrolyte of an all-solid-state Li-ion battery or as component of the positive electrode (posolyte or catholyte) or of the negative electrode (negolyte or anolyte) of an electrochemical system.

### LIST OF THE FIGURES

FIG. 1 represents the conductivity (S/cm) as a function of the inverse of the temperature (1000/T with T in K) for a temperature cycle (descent-rise-descent) between 20 °C and 80 °C of the preparations A-B-C(according to the invention) in the example.

### DESCRIPTION OF THE EMBODIMENTS

### Detailed Description of the Invention

The invention relates to an electrolyte formulation crosslinkable by thiol-ene reactions in which at least one of the monomers contains an anion with delocalized charge such as the TFSI ion, with is covalently bonded and which may include a lithium salt to ensure good transport of the lithium ions in the electrolyte and the catholyte. The formulation makes it possible to obtain crosslinked electrolytes used as solid electrolyte of an all-solid-state Li battery or as a component of the positive electrode (posolyte or catholyte).

The novelty of the invention lies in the development of a single-ion electrolyte, polymerized and crosslinked in situ, which has the advantage of being initially liquid, of forming a chemical network in a single step by a thiol-ene reaction and of exhibiting advantageous lithium ion transport properties for the application, even without the need for solvent. The crosslinkable formulation according to the invention is particularly advantageous for the preparation of all-solid-state battery electrodes. Specifically, it is possible to use electrodes prepared according to the usual methods and immerse them with the precursors of the formulation according to the invention to form in situ an ionic percolation network with good interfaces with the active materials.

In the remainder of the description, a “single-ion” polymer refers to a polymer with self-doped blocks or a polymer with unipolar conduction.

The starting constituents, which are all liquids, are:
a molecule comprising 3 to 6 thiol functions, preferably four, which acts as a crosslinking agent: a tetrafunctional molecule (A₄) may in particular be pentaerythritol tetrakis(3-mercaptopropionate) (preferentially), but a trivalent thiol (A₃) such as trimethylolpropane tris(3-mercaptopropionate) may be used, or alternatively a poly [(mercaptopropyl)methylsiloxane] or a (mercaptopropyl)methylsiloxane-dimethylsiloxane copolymer with an average functionality of greater than or equal to 3;
   a bifunctional chain extender which may be chosen from any oligo- or poly(ethylene glycol) chain bearing two C═C double bonds (B₂): the bifunctional chain extender can thus be a methacrylate, often more stable than acrylates, notably poly(ethylene glycol) dimethacrylate (preferentially). More generally, the bifunctional chain extender can be an oligo- or poly(ethylene glycol) chain bearing two C═C double bonds chosen from the following compounds: PEG diacrylate, PEG dimethacrylate, PEG diallyl, PEG divinyl or any norbornene, vinyl ether, allyl ether, acrylate, methacrylate, maleimide or alkene unit;
a monofunctional single-ion chain terminator (B′₁), containing a C═C double bond providing the mobile lithium and the counteranion which is anchored to the chain, which may in particular be lithium 3-[(trifluoromethane) sulfonamidosulfonyl]propyl methacrylate;
a monofunctional polyethylene glycol chain terminator (B″₁), which may be chosen from poly(ethylene glycol) methyl ether methacrylate, poly(ethylene glycol) methyl ether acrylate, poly(ethylene glycol) allyl methyl ether, poly(ethylene glycol) vinyl methyl ether or poly(ethylene glycol) methyl ether maleimide, etc.

It is not necessary to have the same chemical function on the bifunctional chain extender (B₂) and on the monofunctional PEG chain terminator (B₁″).

It is preferable in the crosslinkable electrolyte formulation according to the invention to respect a molar equivalence of thiol and alkene functionalities (stoichiometry equal to 1). The novelty of the formulation according to the invention lies in the fact that the crosslinking density of the network and its mechanical and physicochemical properties are independent of the amount of single-ion chain terminator (B′₁) owing to the presence of the PEG chain terminator (B″₁). It is therefore easy to adjust the ionic conductivity of the network by acting on the B₁′/B₁″ molar ratio without changing the mechanical properties of the electrolyte.

In one embodiment, it is possible to add a second chain extender of the dithiol family (for example a PDMS or PEG polymer terminated with mercaptoethyl or mercaptopropyl functions at both ends).

The crosslinking reaction is initiated by a catalyst commonly used in the Michael polyaddition reaction, also called an initiator, of nucleophilic base type. The catalyst may be chosen from dimethylphenylphosphine, triphenylphosphine, 1,8-diazabicyclo [5.4.0]undec-7-ene, triethylamine, pyridine or else dimethylaminopyridine, and preferably from 1,8-diazabicyclo [5.4.0]undec-7-ene, dimethylphenylphosphine, triphenylphosphine or triethylamine, even more preferably the catalyst is triethylamine. Advantageously, a molar ratio of thiol function to catalyst of between 200 and 600 is used, which corresponds in particular to a molar ratio of tetrafunctional crosslinking agent to catalyst of about 50 to 150, when the molecule comprising thiols is tetrafunctional (4 thiol functions).

The crosslinkable electrolyte formulation according to the invention therefore comprises at least the following constituents:
a molecule bearing three to six thiol functions, for example four thiol functions (pentaerythritol tetrakis(3-mercaptopropionate) in the examples), or three or six if the flexibility of the final material is to be varied,
a chain extender bearing two C═C double bonds (poly(ethylene glycol) dimethacrylate in the examples): the chain extender is advantageously chosen from any oligo-ethylene glycol unit bearing two C═C double bonds or any norbornene, vinyl ether, allyl ether, acrylate, methacrylate, maleimide or alkene unit,
a monofunctional single-ion chain terminator bearing one C═C double bond which provides the mobile lithium and the counteranion that is anchored, i.e. covalently bonded, to the chain, and makes it possible to generate pendent chains and therefore mechanical flexibility (lithium 3-[(trifluoromethane) sulfonamidosulfonyl]propyl methacrylate in the examples),
a monofunctional polyethylene glycol chain terminator,
a nucleophilic base catalyst (triethylamine in the examples):
   the amount of catalyst to be used is advantageously of the order of 0.04 molar equivalents, the choice of the exact amount being able to be adjusted by a person skilled in the art.

In one embodiment of the invention, the crosslinkable electrolyte formulation comprises:
pentaerythritol tetrakis(3-mercaptopropionate) (A₄);
poly(ethylene glycol) dimethacrylate (B₂);
lithium 3-[(trifluoromethane) sulfonamidosulfonyl]propyl methacrylate (B′₁),
poly(ethylene glycol) methyl ether methacrylate (B″₁),
triethylamine as catalyst, preferably with a molar ratio of tetrafunctional crosslinking agent (A₄) to catalyst of between 50 and 150.

Optionally, it is also possible to add a lithium salt which is soluble in the starting formulation or a mixture of several salts which are soluble in the starting formulation. The lithium salt(s) soluble in the starting formulation are preferably chosen from LiTFSI, LiPF₆, LiFSI, LiClO₄, LITDI, very preferably the soluble lithium salt is LiTFSI, or any mixture of several lithium salts which are soluble in the starting formulation. The exact amount of soluble lithium salt may be between 2% and 30% by weight of the starting formulation and preferentially between 5% and 15% by weight.

It is also possible to add a plasticizer, chosen from the following compounds: oligoethylene glycol, alkyl carbonates, succinonitrile, sparingly volatile polar aprotic solvent or an aprotic ionic liquid. The amount of plasticizer may be between 2% and 30% by weight of the starting formulation and preferentially between 5% and 15% by weight.

The crosslinkable liquid formulation according to the invention can be shaped between two plates or by coating or spraying onto a support, the crosslinking leading to the network is then carried out by heating at a temperature of between 50 °C and 80 °C for a period of between 1 and 24 hours and preferably between 6 and 12 hours. The catholytes or anolytes can be formed by impregnating a porous electrode with the liquid formulation (coating or spraying) or by mixing the liquid formulation with the active material to form an ink, optionally with the presence of a solvent which will be evaporated after crosslinking.

In the case where the solid electrolyte is in contact with the positive electrode, the crosslinkable formulation according to the invention in the liquid state can be coated or sprayed on a positive electrode preprepared according to the protocols of a person skilled in the art in order for the liquid formulation to wet the porosity of the electrode. Finally, crosslinking is obtained after thermal initiation. Preferably, the formulation is coated, or sprayed, and then crosslinked before calendering the electrode.

For example, the formulations according to the invention can be used to formulate a positive electrode (cathode) ink, by adding in particular to the formulation the active material (for example a lithiated nickel-manganese-cobalt mixed oxide or a lithiated iron phosphate) and an electronic percolant. This ink, once coated and dried, can constitute a solid positive electrode.

### Characterization Techniques

The ionic conductivity of an electrolyte is measured in S/cm and characterizes the ability of the electrolyte to transport ions.

The ionic conductivity of the electrolyte is measured by electrochemical impedance spectroscopy in a Biologic® CESH cell. The measurement is carried out at several temperatures using a thermostatically controlled Biologic® ITS chamber. The impedance spectrum is acquired using a Biologic® MTZ 35 potentiostat between 30 MHz and 0.1 Hz around 0 V and with an amplitude of ±10 mV. The conductivity value can be determined by adjustment of the curve with an equivalent circuit of the (R1+R2//CPE1+CPE2) type or visually by taking the value of the real part of the impedance Re(Z) at the minimum reached by the curve between the semicircle and the halfline corresponding to the capacitive part on the Nyquist diagram.

The cation transport number (t+) corresponds to the fraction of the total conductivity related to the transport of charges by the cations and is characterized by impedance spectroscopy on a sample mounted between two nonblocking electrodes (made of lithium metal) at 60 °C with a Biologic VMP3 potentiostat between 1 MHz and 0.1 MHz around 0 V with an amplitude of

10 mV. The transport number is obtained by adjustment of an equivalent circuit (R1+R2//CPE2+R3//CPE3+Wd1) and then by application of the formula: t+=R₂/(R_{Wd1}+R₂). This measurement method corresponds to the “Watanabe” method (Solid State lonics, 28-30 (1988), 911-917).

The solvent swelling test and the calculation of the soluble fraction are conventional methods of characterization of polymer networks in order to have an indirect assessment of their crosslinking density and also of their chemical stability. After immersion of approximately 300 mg of polymer network sample in a large excess of chloroform (CHCl₃) at ambient temperature for 72 hours, the swollen samples are weighed and subsequently vacuum dried.

The soluble fraction (ws) is calculated with the following equation:

ws=1−W_{d}/W₀

with w₀ the initial weight of the sample swollen with solvent (estimated by linear regression on the curve of the weights measured at regular intervals of 0.5 to 5 minutes after having removed the sample from the solvent) and w_{d} the weight of the sample after extraction of the soluble fraction and drying.

The degree of swelling, which corresponds to the gain in volume of the network after immersion in the solvent, (1/q₂) is calculated with the following equation:

1/q₂=ρₚ(q₁−1)/ρₛ

where q₁ is the ratio of the weight of swollen sample to the weight of dry sample, ρₛ is the density of the solvent (ρₛ=1.492 g.cm⁻³ for CHCl₃) and pp is the density of the polymer network.

Various techniques enable the thermomechanical properties of single-ion polymer networks to be characterized.

Differential scanning calorimetry (DSC) is a technique for characterizing thermochemical processes, including phase transitions and changes of state. It is used here to determine the glass transition temperatures (T_{g}) of the polymer networks obtained.

Differential scanning calorimetry (DSC) experiments were carried out with a DSC Q200 (TA Instruments) device calibrated with an indium standard. Samples (5 to 10 mg) were prepared using hermetically sealed capsules and measured in a 25 ml.min⁻¹ flow of helium. The samples were first heated to 120 °C with a heating rate of 10°Cmin⁻¹ and then maintained at this temperature for 2 min. Next, the temperature was brought to −80 °C with a cooling rate of 10°Cmin⁻¹ before heating again, after a 2 min isotherm, up to 200 °C with a heating rate of 10°Cmin⁻¹. The glass transition temperatures (T_{g}) were measured at the half-height of the transitions occurring during the second heat using TA Thermal Analysis software.

Thermogravimetric analysis is a technique that makes it possible to characterize the weight loss profile of a sample subjected to a temperature variation. This characterizes the chemical modifications of the materials as a function of temperature, for example evaporation or chemical degradation.

Thermogravimetric analysis (TGA) experiments were carried out with a TGA Q500 (TA Instruments) device. A 20 °C.min⁻¹ increase in temperature followed by an isotherm at 110 °C for 8 min was carried out to avoid the weight loss due to the presence of water. Next, heating from 20 °C to 600 °C at a rate of 10 °C.min⁻¹ under a continuous 60 ml.min⁻¹ flow of helium was applied to samples of about 8 mg.

### Advantages of the Invention

The crosslinkable electrolyte formulation according to the invention exhibits the advantage, in particular in comparison with prepolymerized polymers, of being liquid at the start, which makes it possible to obtain good cohesion at the interfaces with the electrodes, in particular due to easier filling of the porosity of the materials. The single-ion character (t+=1) leads to a uniform distribution of the Lit ions in the material and thus makes it possible to eliminate the concentration gradient of ions in the material under an electric field (charging and discharging of a battery). Thus, the overvoltages associated with the diffusion of Lit ions through this material are greatly reduced.

The use of controlled crosslinking on a mixture of particular monomers and the particular morphology of the three-dimensional network furthermore confer increased mobility on the chains and consequently improved ionic conduction. The performance qualities of the solid electrolyte according to the invention are based in particular on the specific choice of certain monomers which are very flexible and good solvents for lithium ions and on a controlled crosslinking.

The rheological behavior obtained for the samples of crosslinked electrolyte according to the invention advantageously corresponds to that of a crosslinked polymer.

### Examples

Materials and methods:

For reasons of simplicity of notation, the products making up the network will be named as follows below:
pentaerythritol tetrakis(3-mercaptopropionate): A₄
poly(ethylene glycol) dimethacrylate: B₂
lithium 3-[(trifluoromethane) sulfonamidosulfonyl]propyl methacrylate B′₁
poly(ethylene glycol) methyl ether methacrylate: B″₁
triethylamine: Et₃N

The molar equivalence of functionalities is such that 2 A₄=2 B₂+2 (B′₁+B″₁).

The starting liquid mixture is deposited between two glass plates covered with Teflon tape and separated by a PTFE film which is 200 μm thick for ionic conductivity and transport number measurements, and 2 mm thick for thermomechanical characterizations. The device is placed in an oven at 60 °C for 12 h. The solid samples obtained are dried on a Buchi dryer before being characterized.

The solvent swelling test and the calculation of the soluble fraction are conventional methods for characterization of polymer networks in order to have an indirect estimation of their crosslinking density and also of their chemical stability. These measurements are carried out after immersion of approximately 300 mg of network for 72 hours at ambient temperature in a large excess of chloroform (CHCl₃). The swollen networks are weighed and then dried under vacuum. The content of insolubles is calculated with the following equation:

Ci=(w_{d}/w₀)×100

with w₀ the initial weight of the sample and w_{d} the weight of the sample after extraction of the soluble fraction and drying.

The degree of swelling (1/q₂) is calculated with the following equation:

1/q₂=ρₚ(q₁−1)/ρₛ

where q₁ is the ratio of the weight of swollen sample to the weight of dry sample, ρₛ is the density of the solvent (ρₛ=1.492 g.cm⁻³ for CHCl₃) and pp is the density of the polymer network (ρₚ≈1).

The thermomechanical properties of single-ion polymer networks are characterized by DSC, TGA and DMA in order to determine, respectively, the glass transition value T_{g}, the value of the degradation temperature for 10% weight loss T_{d10} and the values of the storage modulus E′ at the rubbery plateau and of the alpha transition temperature T_{α}.

Differential scanning calorimetry (DSC) experiments were carried out with a DSC Q200 (TA Instruments) device calibrated with an indium standard. Samples (5 to 10 mg) were prepared using hermetically sealed capsules and measured in a 25 ml.min⁻¹ flow of helium. The samples were first heated to 120 °C with a heating rate of 10°Cmin⁻¹ and then maintained at this temperature for 2 min. Next, the temperature was brought to −80 °C with a cooling rate of 10°Cmin⁻¹ before heating again, after a 2 min isotherm, up to 200 °C with a heating rate of 10°Cmin⁻¹. The glass transition temperatures (T_{g}) were measured at the half-height of the transitions occurring during the second heat using TA Thermal Analysis software.

Thermogravimetric analysis (TGA) experiments were carried out with a TGA Q500 (TA Instruments) device. A 20°Cmin⁻¹ increase in temperature followed by an isotherm at 110 °C for 8 min was carried out to avoid the weight loss due to the presence of water. Next, heating from 20 °C to 600 °C at a rate of 10°Cmin⁻¹ under a continuous 60 ml.min⁻¹ flow of helium was applied to samples of about 8 mg.

The ionic conductivity of the electrolyte is measured by impedance spectroscopy in a Biologic® CESH cell. The measurement is carried out at several temperatures using a thermostatically controlled Biologic® ITS chamber. The impedance spectrum is acquired using a Biologic® MTZ potentiostat between 30 MHz and 0.1 Hz around 0 V and with an amplitude of 10 mV.

The transport number of the samples is measured by impedance spectroscopy. The electrolytes are positioned between two lithium metal electrodes and characterized at 60 °C. The impedance spectrum is acquired via a Biologic® VMP3 potentiostat at 0 V with an amplitude of 10 mV between 1 MHz and 0.1 MHz. The impedance spectrum is adjusted by an equivalent circuit and the electrolyte and diffusion resistances can then be extracted. The transport number is calculated from these resistances.

Three formulations were tested in order to vary the molar ratios of the four starting constituents and in particular the amount of lithium in the single-ion network obtained (proportional to the weight percentage of B′₁) and in order to test the impact of adding a lithium salt (here LiTFSI) and a plasticizer (here succinonitrile). The catalyst (initiator of nucleophilic base type) is added last and its molar equivalent is invariant (0.04). Table 1 shows the compositions, as molar equivalents, of samples A to C and weight % of the lithiated chain terminator and of the plasticizer in the starting formulation.

TABLE 1

| | | | | | LiTFSI | Succinonitrile |
|---|---|---|---|---|---|---|
| | A₄ | B₂ | B′₁ | B″₁ | Molar eq. | weight % |
| A | 4 | 5 | 5 | 1 | 0 | 0 |
| | | | (i.e. 26 | | | |
| | | | wt %) | | | |
| B | 4 | 5 | 6 | 0 | 0 | 0 |
| | | | (i.e. 32 | | | |
| | | | wt %) | | | |
| C | 4 | 5 | 6 | 0 | 1 | 10 |
| | | | (i.e. 32 | | | |
| | | | wt %) | | | |

Table 2 presents the results obtained following immersion of the networks in chloroform at ambient temperature (content of insolubles Ci and degree of swelling S of the networks A to C). It is noted that the three formulations lead to materials which have a good chemical stability, because the contents of insolubles are all greater than 85%. The swelling values, which are low (all less than 5) reflect a very good crosslinking of the networks.

TABLE 2

| | S | Ci (%) |
|---|---|---|
| A | 4.5 | 91 |
| B | 4.3 | 87 |
| C | 3.1 | 90 |

Table 3 (glass transition temperature T_{g} and decomposition temperature for 10% of the initial weight T_{d10} of the networks A to C) presents the results obtained from the DSC and TGA analyses. It is noted that the glass transition temperature is low (it does not exceed-15 °C) which reflects an adequate segmental mobility for the transport of lithium over the operating temperature range of a battery. The three formulations tested have a decomposition temperature for 10% of the initial weight of greater than 280 °C, which is entirely satisfactory for the intended field of application.

TABLE 3

| | T_{g} (°C) | T_{d10} (°C) |
|---|---|---|
| A | −20 | 314 |
| B | −17 | 316 |
| C | −21 | 283 |

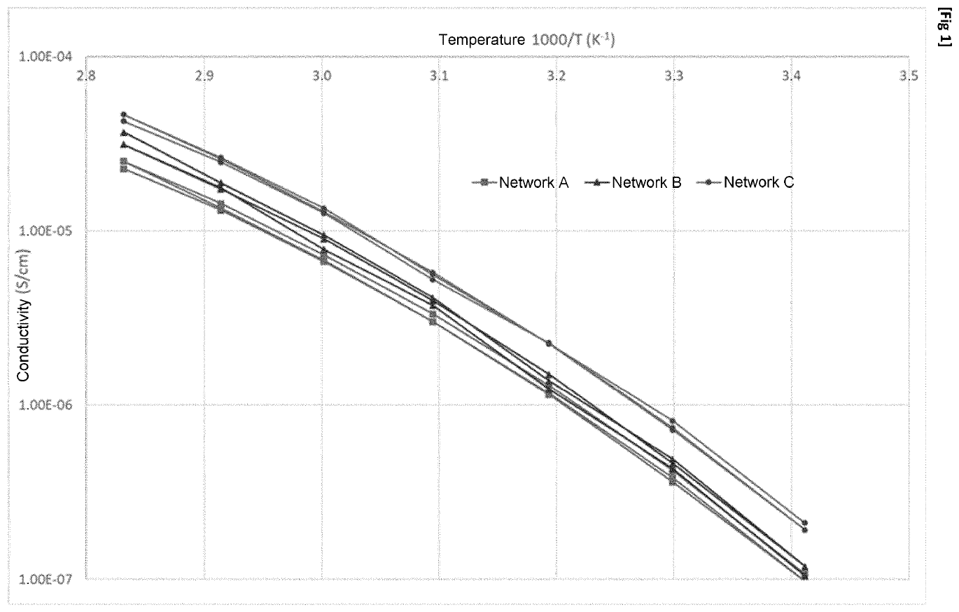

FIG. 1 shows the conductivity measurements of the networks obtained from the three 5 formulations tested A, B, C. It is observed that when the weight fraction of single-ion chain terminator increases from 26% to 32% by weight, the conductivity of the final network also increases due to the supply of mobile lithium ions to the system (6.7×10⁻⁶ vs 9.5×10⁻⁶ S.cm⁻¹ at 60 °C). In addition, if a small amount of lithium salt and plasticizer is added to the starting formulation, the conductivity is further improved (1.4×10⁻⁵ S.cm⁻¹ at 60 °C).

The transport numbers obtained for formulations A and B are equal to one, which is characteristic of a single-ion system. The network C has a transport number of less than 1, due to the presence of the lithium salt.

1. A crosslinkable electrolyte formulation comprising at least:
a hydrocarbon molecule containing three to six thiol functions, preferably four;
a bifunctional chain extender in the form of a hydrocarbon chain bearing two C═C double bonds;
a monofunctional single-ion chain terminator containing a C═C double bond and comprising mobile lithium;
a monofunctional polyethylene glycol chain terminator;
a nucleophilic base catalyst,
wherein the [C═C double bond]/[thiols] molar ratio is 1.

2. The crosslinkable electrolyte formulation as claimed in claim 1, which comprises a soluble lithium salt or a mixture of soluble lithium salts in the formulation and wherein the amount of lithium salt(s) represents between 2% and 30% by weight, relative to the total formulation weight, preferably between 5% and 15% by weight, relative to the total formulation weight.

3. The crosslinkable electrolyte formulation as claimed in claim 1, wherein the catalyst is chosen from 1,8-diazabicyclo [5.4.0]undec-7-ene, dimethylphenylphosphine, triphenylphosphine or triethylamine, pyridine and dimethylaminopyridine and preferably chosen from 1,8-diazabicyclo [5.4.0]undec-7-ene, dimethylphenylphosphine, triphenylphosphine or triethylamine, very preferably triethylamine.

4. The crosslinkable electrolyte formulation as claimed in claim 1, wherein the hydrocarbon molecule containing 3 to 6 thiol functions is chosen from pentaerythritol tetrakis(3-mercaptopropionate), trimethylolpropane tris(3-mercaptopropionate), a poly [(mercaptopropyl)methylsiloxane] or a (mercaptopropyl)methylsiloxane-co-dimethylsiloxane copolymer with an average functionality of greater than or equal to 3, preferably is pentaerythritol tetrakis(3-mercaptopropionate).

5. The crosslinkable electrolyte formulation as claimed in claim 1, wherein the bifunctional chain extender is chosen from any oligoethylene glycol unit bearing two C═C double bonds or any norbornene, vinyl ether, allyl ether, acrylate, methacrylate or alkene unit.

6. The crosslinkable electrolyte formulation as claimed in claim 5 wherein the bifunctional chain extender is chosen from poly(ethylene glycol) dimethacrylate, PEG diacrylate, PEG diallyl, PEG divinyl.

7. The crosslinkable electrolyte formulation as claimed in claim 1, wherein the monofunctional single-ion chain terminator is lithium 3-[(trifluoromethane) sulfonamidosulfonyl]propyl methacrylate.

8. The crosslinkable electrolyte formulation as claimed in claim 1, wherein the polyethylene glycol chain terminator is chosen from poly(ethylene glycol) methyl ether acrylate, poly(ethylene glycol) allyl methyl ether, poly(ethylene glycol) vinyl methyl ether or poly(ethylene glycol) maleimide methyl ether.

9. The crosslinkable electrolyte formulation as claimed in claim 1, comprising the catalyst in an amount such that the molar ratio of thiol functions to catalyst is between 200 and 600.

10. The crosslinkable electrolyte formulation as claimed in claim 1, comprising a second chain extender of the dithiol family, preferably chosen from polydimethylsiloxane (PDMS) or polyethylene glycol (PEG) polymers terminated with mercaptoethyl or mercaptopropyl functions at both ends.

11. The crosslinkable electrolyte formulation as claimed in claim 1, comprising a plasticizer chosen from the following compounds: oligoethylene glycol, carbonate ester, succinonitrile, polar aprotic solvent or aprotic ionic liquid, said plasticizer representing from 2% to 30%, preferably from 5% to 15% by weight, relative to the total formulation weight.

12. A process for preparing a crosslinked solid electrolyte, wherein:
a) the crosslinkable electrolyte formulation as claimed in claim 1 is crosslinked, in the optional presence of a nonaqueous solvent, by means of the catalyst present in the formulation and by thermal activation, in order to form a polymer which conducts lithium ions,
b) the optional solvent present in said polymer is evaporated in order to obtain a crosslinked solid electrolyte.

13. The process for preparing a crosslinked solid electrolyte as claimed in claim 12, wherein the thermal activation is carried out by heating the formulation at a temperature of between 50 °C and 80 °C for a period of between 1 and 24 hours and preferentially between 6 hours and 12 hours.

14. The process for preparing a crosslinked solid electrolyte in electrode form as claimed in 12, wherein in step a) a porous electrode is impregnated with the crosslinkable electrolyte formulation by coating or spraying, and then the coated or sprayed formulation is crosslinked, or an active material and an electronic percolant are added to the crosslinkable electrolyte formulation in step a) to formulate an electrode ink which is coated and then crosslinked to obtain a solid electrode.

15. The use of the crosslinked electrolyte obtained by crosslinking of the formulation as claimed in claim 1 as solid electrolyte of an all-solid-state Li-ion battery or as component of the positive electrode (posolyte or catholyte) or of the negative electrode (negolyte or anolyte) of an electrochemical system.
